(19) United States
(12) Patent Application Publication
(10) Pub. No.: US 2024/0411886 A1
(43) Pub. Date: Dec. 12, 2024

(54) METHODS AND SYSTEMS FOR SECURITY SOFTWARE PATCH TYPE DETECTION

(71) Applicant: George Mason University, Fairfax, VA (US)

(72) Inventors: Kun Sun, Fairfax, VA (US); Xinda Wang, Fairfax, VA (US); Shu Wang, Fairfax, VA (US)

(21) Appl. No.: 18/431,443

(22) Filed: Feb. 2, 2024

Related U.S. Application Data
(60) Provisional application No. 63/456,631, filed on Apr. 3, 2023.

(51) Int. Cl. G06F 21/57; G06F 8/65

(52) U.S. Cl. CPC G06F 21/572; G06F 8/65; G06F 2221/033

(57) ABSTRACT

Methods and systems are provided for security patch type detection of software patches. A software patch for a software product may be received. For example, the software patch may be received by a computing device. A pre-patch code property graph and a post-patch code property graph may be determined. For example, the pre-patch code property graph and the post-patch code property graph may be determined based on the software patch and/or the pre-patch source code and the post-patch source code respectively. A combined patch code property graph may be determined. For example, the combined patch code property graph may be determined based on the pre-patch code property graph and the post-patch code property graph. A patch type for the software patch may be determined. For example, the patch type may be determined based on the combined patch code property graph and/or a machine-learning prediction model.

### CROSS-REFERENCE TO RELATED APPLICATIONS

This application claims priority to U.S. Provisional Patent Application No. 63/456,631, filed Apr. 3, 2023, the entire contents of which are hereby incorporated herein by reference into this application.

### STATEMENT REGARDING FEDERALLY SPONSORED RESEARCH

This invention was made with government support under grant number W56KGU-20-C-0008 awarded by the Unites States Army. The government has certain rights in the invention.

### BACKGROUND

While the open source software (OSS) movement has made great contributions to computer software development, the number of OSS vulnerabilities has increased dramatically. As announced by the 2021 Open Source Security Risk Analysis report, 98% of codebases contain open source components. Meanwhile, 84% of code-bases have at least one open-source vulnerability, and 60% of those code-bases contain high-risk vulnerabilities. By exploiting the OSS vulnerabilities reported in the vulnerability databases, attackers can perform “N-day” attacks against unpatched software systems. For instance, the remote command execution vulnerability (CVE-2021-22205) was initially released on April 2021. However, after seven months, over 30,000 unpatched GitLab servers have been compromised and misused to launch distributed denial of service (DDOS) attacks.

Timely software patching is an effective common practice to reduce attacks directed to software vulnerabilities. Unfortunately, users or system administrators are often overwhelmed with the increasing large number of various patches they are asked to apply to their software systems, Further the functionality or basis for applying these patches may vary. For example, patches may be provided for adding new features to the software, resolving performance bugs, or fixing security vulnerabilities. Given the large number of patches users or system administrators may receive, the requested software updates (patches) could be postponed, due to the workflow of collecting, testing, validating, and scheduling the application of the patches. To address this software patching challenge, it becomes critical for users and system administrators to distinguish the security patches from other patches and prioritize the patches for fixing security vulnerabilities. However, not all the security patches are reported to the National Vulnerability Database (NVD) or explicitly recognized in the changelog. In addition, some software vendors may silently release security patches since the patch management is quite subjective. For those silent security patches, it is hard for users and system administrators to understand their real security impacts. As such, those users and system administrators may fail to set a high priority for applying those patches. Therefore, it is vital to distinguish security patches from software patches designed for other purposes.

Conventional methods for identifying security patches include using machine learning (ML) methods with syntax features or performing recurrent neural networks (RNNs) to handle the patch code as a sequential data structure. However, these conventional solutions have two major drawbacks: lack of program semantics and high false-positive rate. First, with the focus on code syntax only, conventional methods for identifying security patches achieve a relatively low accuracy on detecting those security patches. For example, the ML-based methods focus on extracting the metadata and keyword features, missing the dependencies between statements. Inspired by natural language processing (NLP) techniques, RNN-based methods segment the programs as a set of code tokens and leverage sequential models to identify security patches. However, they ignore the unique properties of programming languages on component units, dependency relationships, and token types. Second, the high false-positive rates of conventional methods for identifying security patches limit their usage. For instance, two twin RNN-based solutions that leverage both source code and commit messages have the false-positive rates of 11.6% and 33.2%, respectively. Considering that only 6-10% of overall patches are security-related, it is imperative to reduce the false positives.

### SUMMARY

It is understood that both the following general description and the following detailed description are exemplary and explanatory only and are not restrictive.

Methods and systems are provided for security patch type detection of software patches. A software patch for a software product may be received. For example, the software patch may be received by a computing device. A pre-patch code property graph and a post-patch code property graph may be determined. For example, the pre-patch code property graph and the post-patch code property graph may be determined based on the software patch and/or the pre-patch source code and the post-patch source code respectively. A combined patch code property graph may be determined. For example, the combined patch code property graph may be determined based on the pre-patch code property graph and the post-patch code property graph. A patch type for the software patch may be determined. For example, the patch type may be determined based on the combined patch code property graph and/or a machine-learning prediction model.

Additional advantages will be set forth in part in the description which follows or may be learned by practice. The advantages will be realized and attained by means of the elements and combinations particularly pointed out in the appended claims. It is to be understood that both the foregoing general description and the following detailed description are provided for example only and are not restrictive.

### BRIEF DESCRIPTION OF THE DRAWINGS

The accompanying drawings, which are incorporated in and constitute a part of the present description serve to explain the principles of the methods and systems described herein. To easily identify the discussion of any particular element or act, the most significant digit or digits in a reference number may refer to the figure number in which that element is first introduced.

FIG. 1 shows an example method;

FIG. 2 shows an example method;

FIG. 3 shows an example patch code property graph;

FIG. 4 shows an example system;

FIG. 5 shows an example method;

FIG. 6 shows an example system;

FIG. 7 shows and example method;

FIGS. 8A-F show example subgraphs of patch code property graphs;

FIG. 9 shows an example graph convolution method;

FIGS. 10A-D show example weight impact graphs; and

FIG. 11 shown a flowchart of an example method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes-from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, a computer program product on a computer-readable storage medium (e.g., non-transitory) having processor-executable instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These processor-executable instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These processor-executable instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the terms “user,” or “subject,” may indicate a person who uses an electronic device or a device (e.g., an artificial intelligence electronic device) that uses an electronic device.

Open source software patches may record the changes between two different versions of source code. The best practices for capturing a snapshot of a software's proposed changes may include making single-purpose commit followed by well-maintained global information tracker (Git) repositories. For example, a “patch” may be or include single-purpose Git commit for addressing a security vulnerability (a security fix), resolving a functionality bug (a non-security repair), or updating a new feature. Security patches are usually considered more urgent and given higher priority than non-security patches. For example, a patch may comprise a “security patch” if it fixes a vulnerability belonging to any Common Weakness Enumeration Specification (CWE) type in the software.

Listings 1 and 2 below show one of a variety of possible examples of a security patch (Listing 1) and a non-security patch (Listing 2), respectively. The code revision for the particular patch may be represented as a set of consecutive deleted and/or added statements (e.g., the lines starting with a single (−) or (+) symbol). For example, in Listing 1, an if statement (Line 8) is shown as being added before the original assignment statement to check if the pointer “tcon” is valid. This security patch of Listing I was designed to mitigate a NULL pointer dereference vulnerability, where an invalid pointer with a value of NULL can lead to a crash or exit from the software. Listing 2 shows an example of a non-security patch. For example, in Listing 2, an obsolete identifier hack is deleted since the obsolete identifier hack is no longer used in the subsequent code. However, this variable definition (Line 7) will not incur any security problems.

Listing 1: An example of a security patch

| 1 | commit 18f39e7be0121317550d03e267e3ebd4dbfbb3ce | |
|---|---|---|
| 2 | diff --git a/fs/cifs/smb2pdu.c b/fs/cifs/smb2pdu.c | |
| 3 | @@ −907,7 +907,8 @@ tcon_exit: | |
| 4 | tcon_error_exit: | |
| 5 | | if (rsp−>hdr.Status == STATUS_BAD_NETWORK_NAME) { |
| 6 | | cifs_dbg(VFS, “BAD_NETWORK_NAME: %s\n”, tree); |
| 7 | − | tcon−>bad_network_name = true; |
| 8 | + | if (tcon) |
| 9 | + | tcon−>bad_network_name = true; |
| 10 | | } |
| 11 | | goto tcon_exit; |
| 12 | | } |

Listing 2: An example of a non-security patch

| 1 | commit 6cf575b1ad989fbb8a239dd6acc26d72286eb4cb | |
|---|---|---|
| 2 | diff --git a/src/path.c b/src/path.c | |
| 3 | @@ −1145,7 +1145,6 @@ int git_path_diriter_init( | |
| 4 | | unsigned int flags) |
| 5 | | { |
| 6 | | git_win32_path path_filter; |
| 7 | − | git_buf hack = {0}; |
| 8 | | |
| 9 | | static int is_win7_or_later = −1; |
| 10 | | if (is_win7_or_later < 0) |

Software patches may typically include not only the lines of code that will be added and/or removed but also neighboring lines of the code adjacent to the area of the patch within the software. These neighboring lines of code may precede the area of the code being added and/or deleted in the patch and/or be after the area of the code being added and/or deleted in the patch. For example, a software patch may contain six neighboring code lines (e.g., three lines or code preceding the changes and three lines of code following the changes proposed by the software patch, such as line 4-6 and 8-10 in Listing 2). These neighboring lines of code may be provided as context for each code revision. While the example above suggests six lines of code, this is for example purposes only as fewer or greater than six lines of neighboring code may be provided with the software patch. In some examples, these context statements provided by the neighboring code may not provide sufficient semantics to understand the function or operation of the software patch. However, to perform code analysis on an OSS patch, the source code may be retrieved showing the code both before “pre-patch” and after “post-patch” applying the software patch. For example, a software patch may be considered as a security patch when a vulnerability exists in the pre-patch code and the corresponding fix statement(s) are in the post-patch code. In certain examples, security patches may comprise sanity checks, which are security checks on critical values like bound, permission, etc. For example, for the software patch to fix use-after-free and double-free vulnerabilities, sanity checks may be the added conditional statements to check the availability of pointers or memory.

Code property graph (CPG) is a language-agnostic intermediate program representation, which merges multiple abstract representations of source code into one queryable graph database. The CPG may merge two or more of three compiler representations (i.e., Abstract Syntax Tree (AST), Control Flow Graph (CFG), and Program Dependence Graph (PDG)) into a single joint data structure. AST is a code representation generated by the syntax analysis of a compiler. CFG is a graph structure that represents all the possible traversed paths during program execution. PDG comprises of control dependency graph (CDG) and data dependency graph (DDG) to represent the control and data dependencies, respectively. By containing all the information of control flow, control dependency, intraprocedural data dependency, and program syntax, CPG may provide a comprehensive view for code static analysis. The open-source platform Joern can generate CPGs and represent the output CPGs with nodes, labeled directed edges, and key-value pairs (e.g., node attributes). Accordingly, CPGs for patches may be extended with more semantics between pre-patch and post-patch code.

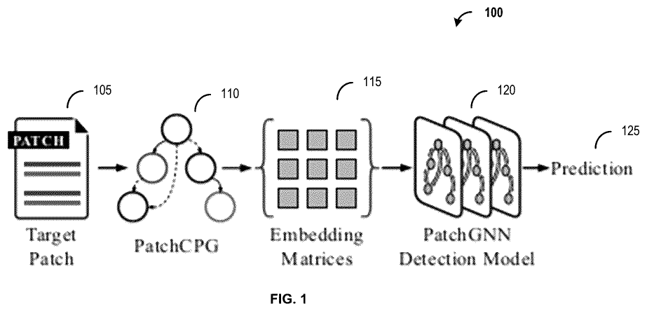

FIG. 1 is an example method 100 for predicting whether a patch is a security patch. The method 100 may be completed by a computing device 602 or any other computing device described herein. At 105 a target software patch may be received. For example, the target software patch may be received from a local or remote database and/or from the software developer for the software associated with the target software patch. For example, the target software patch may comprise an OSS patch. The target software patch may be an input for the method 100. At 110, the target software patch may be mapped to an intermediate graph representation patchCPG. For example, the intermediate graph representation patchCPG may contain control/data dependency and program syntax. At 115, one or more nodes and/or edges of the intermediate graph representation patchCPG may be converted into embedding matrices. At 120, the embedded matrices may be fed into a graph-based deep neural network PatchGNN detection model. At 125, the PatchGNN detection model may predict if the target software patch is either a security or a non-security software patch. For example, the prediction may be based on the embedding matrices.

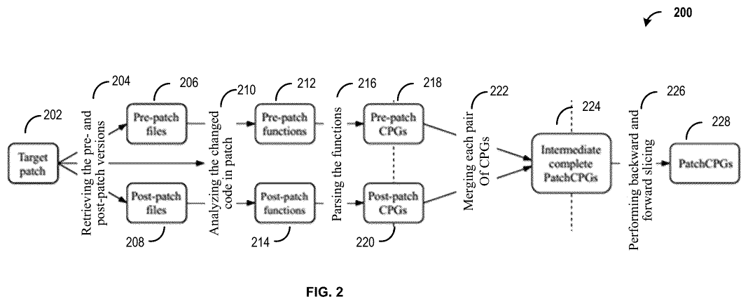

FIG. 2 is an example method 200 for mapping a target software patch to a graph representation patchCPG. For example, the method 200 may be completed by a computing device 602 or any other computing device described herein. The example method 200 may comprises one way for completing 110 of FIG. 1. The method 200 may convert the target software patch into an intermediate graphical representation that can be processed by neural networks and machine-learning prediction models. The graphical representation may embed richer information such as control/data dependency information into the graph for analysis by the prediction model. For example, the graph-based data structure may be referred to as patchCPG to represent the software patches in C/C++ programming languages.

At 202, a target software patch may be received. For example, the target software patch may be received from a local or remote database and/or from the software developer for the software associated with the target software patch. At 204, the pre-patch source code 206 and the post-patch source code 208 are retrieved. For example, the pre-patch source code 206 and the post-patch source code 208 may be retrieved based on the received target software patch. Though the target patch contains multiple lines of context code (e.g., three lines ahead and behind the changed code snippet), critical context related to the target software patch and outside the range of the context code may be missed. Accordingly, the computing device may retrieve the files of full source code before and after applying the patch. Thus, we can obtain the source code files of both pre-patch and post-patch versions. To retrieve the related files in pre-patch 206 and post-patch 208 versions, we implement a parser to analyze the target software patch 202. For example, the target software patch 202 may comprise a software identifier that identifies the software to which the target patch is to be applied. For example, each target patch can be uniquely identified by a commit ID (e.g., a 20-byte SHA-1 hash). For example, the computing device may retrieve and/or receive the pre-patch source code 206 and the post-patch source code based on the software identifier. For example, given the commit ID of the target patch, the source code can be rolled back exactly to the point before and after applying the target patch by using, for example, a git reset command.

For example, the pre-patch source code 206 and the post-patch source code 208 may be received and evaluated in order to obtain more context details for the target software patch. For example, the pre-patch source code 206 may reveal the vulnerability patterns, while the post-patch source code 208 may indicate the fixing details.

At 210, the code in the pre-patch source code 206 and the post-patch source code 208 is analyzed. For example the code is analyzed to determine the functions involved in the patch within the source code 206, 208 and the functions not involved in the patch within the source code 206, 208. There may be multiple code files in each software version of the pre-patch source code 206 and the post-patch source code 208. However, analysis may be limited to the files modified by the target software patch. For example, these files within the target software page may be identified by the header lines starting with −−− and +++ (e.g., Line 3-4 in Listing 3). An analysis may be conducted to determine the functions containing code revisions in the target software patch. Unrevised functions from the source code 206, 208 may be removed instead of retaining all revised functions. For example, all functions within the source code 206, 208 may be determined. The scope (e.g., the line number range between function start and function end) of the determined functions within the source code 206, 208 may further be determined via a parser, such as a Joern parser. For example, the target software patch may contain the scope or range information showing the line numbers of changed code in pre-patch 206 and post-patch 208 source code files, e.g., in Line 5 of Listing 3, Line 3439 is deleted from the unpatched file and Line 3444-3447 arc added to the patched file. The scopes of the pre-patch 206 and post-patch 208 source code may be compared with those line numbers of the code revised by the target software patch.

For example, the computing device may determine the pre-patch functions 212 involved in the patch within the pre-patch source code 206 and, at 216, may remove the pre-patch functions not involved in the patch within the pre-patch source code 206 from the pre-patch source code. For example, the computing device may determine the post-patch functions 214 involved in the patch within the post-patch source code 208 and at 216, may remove the post-patch functions not involved in the patch within the post-patch source code 208 from the post-patch source code. After removing functions that do not contain code revisions, what is left is the patch-related functions 212, 214.

Listing 3: A security patch for buffer overflow vulnerability

| 1 | diff --git a/core/tee/tee_svc_cryp.c b/core/tee/ tee_svc_cryp.c | | |
|---|---|---|---|
| 2 | index a5beb339cc9..f60f3d248c2 100644 | | |
| 3 | −−− a/core/tee/tee_svc_cryp.c | | |
| 4 | +++ b/core/tee/tee_svc_cryp.c | | |
| 5 | @@ −3439 +3444,4 @@ TEE_Result syscall_asymm_verify( | | |
| | | unsigned | |
| 6 | TEE_Result syscall_asymm_verify(unsigned long state, const struct utee_attribute | | |
| | | *usr_params, size_t num_params, const void *data, size_t data_len, const void | |
| | | *sig, size_t sig_len) | |
| 7 | { | | |
| 8 | | TEE_Result res; | |
| 9 | | TEE_Attribute *params = NULL; | |
| 10 | | struct user_ta_ctx *utc; | |
| 11 | | | |
| 12 | | ... | |
| 13 | | | |
| 14 | | res = tee_mmu_check_access_rights(utc, | |
| | | TEE_MEMORY_ACCESS_READ \| TEE_MEMORY_ACCESS_ANY_OWNER, | |
| | | (uaddr_t)sig, sig_len) ; | |
| 15 | | if (res != TEE_SUCCESS) | |
| 16 | | return res; | |
| 17 | | | |
| 18 | | − | params = malloc(sizeof(TEE_Attribute) * num_params); |
| 19 | | + | size_t alloc_size = 0; |
| 20 | | + | if (MUL_OVERFLOW(sizeof(TEE_Attribute), num_params, |
| | | | &alloc_size)) |
| 21 | | + | return TEE_ERROR_OVERFLOW; |
| 22 | | + | params = malloc(alloc_size); |
| 23 | | | |
| 24 | | if (!params) | |
| 25 | | return TEE_ERROR_OUT_OF_MEMORY; | |
| 26 | | res = copy_in_attrs(utc, usr_params, num_params, | |
| | | params); | |
| 27 | | if (res != TEE_SUCCESS) | |
| 28 | | goto out; | |
| 29 | | | |
| 30 | | ... | |
| 31 | | | |
| 32 | out: | | |
| 33 | | free(params); | |
| 34 | | return res; | |
| 35 | } | | |

At 218, a pre-patch CPG is generated. For example, the pre-patch CPG may be generated based on the pre-patch source code 206, such as pre-patch functions 212 involved in the target software patch. At 220, a post-patch CPG is generated. For example, the post-patch CPG may be generated based on the post-patch source code 208, such as the post-patch functions 214. For example, the Joern parser may be used to generate the pre-patch CPG 218 and the post-patch CPG 220 (e.g., Gₚᵣₑ and Gₚₒₛₜ respectively). For example, in each CPG 218, 220, the graph may be described with two sets: (V, E). For example, V is a set of nodes represented with 2-tuple (id, code), where id is a number to identify the node and code is the source code component depicted by this node (e.g., a code token in AST or a statement in CDG/DDG). E may comprise a set of directed edges represented with 3-tuple (id₁, id₂, type), where id₁ and id₂ represent the IDs of start and end nodes. type∈{AST, CDG, DDG} is the edge type indicating if the edge belongs to the AST or denotes control/data dependency. Therefore, two separate CPGs 218, 220 of the pre-patch 206 and post-patch 208 source code are generated, respectively.

At 222, the pre-patch CPG 218 and the post-patch CPG are merged into an intermediate complete patchCPG 224. For example, the intermediate complete patchCPG 224 is a data structure constructed by merging the CPGs 218, 220 of pre-patch 206 and post-patch 208 source code. The merging principle is to retain the shared context components in both CPGs 218, 220 and then attach the deleted and added components from the pre-patch CPG 218 and post-patch CPG 220, respectively. Therefore, intermediate complete patchCPG 224 is a unified graph containing nodes and edges from two different versions of the source code 206, 208.

For example, for each pair of pre-patch 212 and post-patch 214 functions, we merge the corresponding pre-patchCPG 216 and post-patchCPG 218 into a unified graph structure called the intermediate complete patchCPG 224. The function names are used to pair the functions in the pre-patch files 206 with the corresponding ones in the post-patch files 208. According to the code revision of the target software patch 202, we define three types of components in an intermediate complete patchCPG 224. A first component may be deleted components. Deleted components may be nodes and edges in the pre-patchCPG 218 that do not appear in the post-patchCPG 220. For a security patch, the deleted components may be highly relevant to the vulnerabilities of the software. A second component may be added components. Added components may be nodes and edges that only exist in the post-patchCPG 220 and are not in the pre-patchCPG 218. For a security patch, the added components are usually the operations to fix the vulnerabilities. A third component may be context components. Context components are the nodes and edges corresponding to unchanged statements that appear in both pre-patch 212 and post-patch 214 functions. Though these components are not modified by patches, the context components contain context information that is related to the deleted or added statements.

The example reason for merging the pre-patchCPG 218 and the post-patchCPG 220 into the intermediate complete patchCPG 224 is to retain the context components and attach the deleted and added components in a unified graph. Given the pre-patch 218 and post-patch 220 CPGs, the algorithm may merge them into the intermediate complete patchCPG 224 in the following manner. First, determining the node versions. For example, determining the node versions may comprise the computing device, for each node, determining if it is a deleted, added, or context component. Second, identifying the edge versions. For example, determining the edge versions may comprise the computing device, for each edge, determining if one of its connected nodes is a deleted or an added component. If so, the edge may be marked as the corresponding component. For example, an edge is a context component only if both of its connected nodes are context. Third, re-assigning node IDs and merging the node and edge sets. For example, the computing device may reassign each node a new node ID since the node IDs in pre-patch 218 and post-patch 220 CPGs may be conflicting. After updating the node IDs in the edge sets, the computing device may merge the node/edge sets of pre-patch 218 and post-patch 220 CPGs into a unified node/edge set. In this way, we obtain the intermediate complete patchCPG 224 depicted by two sets (V′, E′), where V′=Vₚᵣₑ∪Vₚₒₛₜ and E′=Eₚᵣₑ∪Eₚₒₛₜ. The computing system may further append an additional element version to each tuple of nodes/edges. Thus, the node set V′ may be represented with 3-tuples (id, code, version) and the edge set E′ may be represented with 4-tuples (id₁, id₂, type, version), where version∈{deleted, added, context} is the version information denoting which type of component in the intermediate complete patchCPG 224 the node/edge belongs to.

At 226, a program slicing technique may be applied to the intermediate complete patchCPG 224. For example, the program slicing technique 226 may comprise backward and/or forward slicing of the intermediate complete patchCPG 224 to generate the patchCPG 228. For example, the program slicing technique 226 may limit the range of context code according to the hop count towards the nodes of deleted/added statements.

In the proposed systems and methods, it may be unnecessary to include all the statements in a function since some of them are irrelevant to vulnerabilities. To locate the vulnerability-relevant context statements, the computing device performs the program slicing technique 226 on the source code with the criterion of deleted/added statements. Different from the traditional definition in a target software patch 202 where adjacent statements of changed code are regarded as context, the computing device defines the sliced statements as context since only these statements have dependencies with the changed ones. The program slicing technique 226 may be performed in two directions: backward slicing and forward slicing.

During backward slicing, the computing device determines the source of the vulnerability. For example, when a deleted statement (e.g., Line 18 in Listing 3) is set as the criterion, the results of backward slicing are the statements in Line 6 and 15. Line 18 is data dependent on Line 6 since the variable params is determined by the argument num_params in the current function. Line 18 is control dependent on Line 15 since Line 18 can be executed only when the condition in Line 15 is not satisfied. Otherwise, the function will directly return. After backward slicing, the nodes of Line 6 and 15, the data dependency edge between Line 6 and 18, as well as the control dependency edge between Line 15 and 18 will be retained as backward context.

During forward slicing the computing device determines statements affected by the vulnerability. For example, in Listing 3, when the computing device sets the added statement in Line 22 as a criterion, the results of forward slicing are the statements in Line 24, 26, and 27 that are directly/indirectly data dependent on the variable params. However, the forward slicing results of Line 20 include all the subsequent statements (e.g., Line 21-34). That is because the program will directly return in Line 21 if the condition in Line 20 is true. In this case, considering all the subsequent statements as context may lead to too much noise since they are not highly relevant to the criterion statements. Thus, when the criterion happens to be a conditional statement that leads to a function exit point (e.g., return), the computing device may no longer consider the subsequent slicing results with control dependency. Therefore, the nodes of Line 24, 26, and 27 as well as the data dependency edges between Line 22 are retained as forward context.

After performing backward and forward slicing using control and data dependency, the computing device retain all the nodes of changed and sliced statements, as well as the traced edges. Note that the slicing is only conducted in the CDG and DDG where each node represents a statement. In patchCPG, each AST is constructed based on a statement node (e.g., a node in CDG or DDG). Therefore, after determining the nodes in CDG and DDG, it may be trivial to include all the AST components that are dependent on the retained context nodes. The computing device may iteratively conduct slicing to determine all the context statements that directly and indirectly depend on the criterion statements. In Listing 3, Lines 24 and 26 are directly dependent on the variable params in Line 22. Since params decides the value of res in Line 26 while Line 27 checks if res is equal to a specific value, Line 27 is indirectly data dependent on Line 22. Moreover, more statements in the omitted part is indirectly dependent on Line 22 and they are less relevant to the changed statement. To reduce the noisy portion, the computing device may empirically set the number of iteration times, denoted as N. For instance, when the number of iterations is set to N=1, the sliced statements of the changed code in Listing 3 will include Line 6, 15, 24, and 26. When the number of iterations is set to N=2, the computing device will further add Line 27 into the patchCPG.

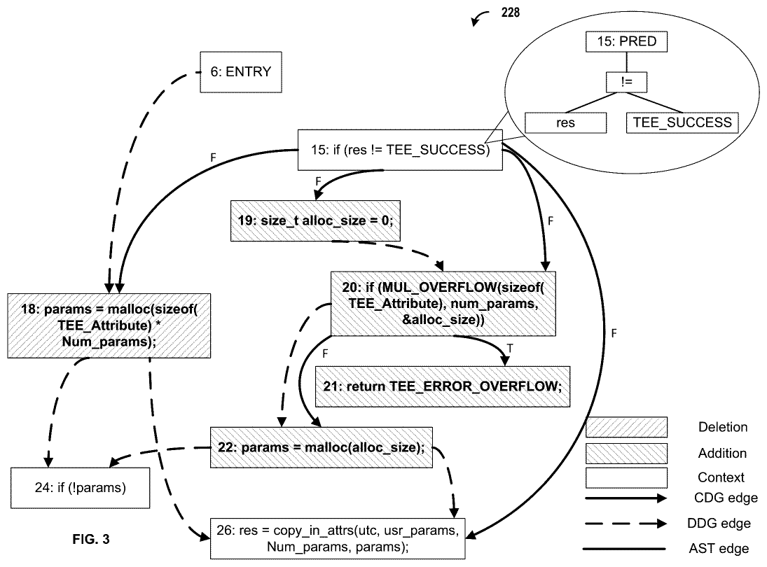

FIG. 3 presents the constructed patchCPG 228 for Listing 3. In FIG. 3, the solid/dotted edges denote control/data dependencies and red/green/white rectangles represent deleted/added/context statements. In this example patchCPG 228, the number of iterations was set to N=/so that all the retained context statements are directly dependent on the changed code. In FIG. 3, the computing device omits most AST subgraphs of each statement and only shows an example for the statement of Line 15.

To feed patchCPG 228 into a machine-learning prediction model, such as a GNN-based model, the computing device may embed the attributes in the patchCPG graph into numeric vectors. For example, the patchCPG graph attributes may contain two parts: edge attributes and node attributes. Edge attributes may represent the relationships between the nodes in the patchCPG graph. Node attributes may represent the code snippet in each node, either a statement or a code token.

The computing device employs edge embedding to reflect the relationships between two nodes. The edges in patchCPG 228 involve two types of relationships. For example, the two types of relationships may include version information and edge types. The version information may refer to whether the edge is present only in the pre-patchCPG version 218 or post-patchCPG version 220 or in both versions. The edge type may refer to whether the edge belongs to the CDG, DDG, or AST. In certain examples, there are two edges, one from CDG and the other from DDG, between the two nodes. Therefore, the edge embedding may be designed as a 5-dimensional binary vector. The first two bits of the edge embedding may be used to indicate if the edge is present in the pre-patchCPG version 218 and the post-patchCPG version 220, respectively. If the edge belongs to both the pre-patchCPG version 218 and the post-patchCPG version 220, the first two bits will be (1, 1). The last three bits of the edge embedding may be used to indicate if there are any CDG, DDG, or AST edge between the two current nodes, respectively.

Node embedding is a numeric representation of the code in each patchCPG node, which can be a statement in CDG/DDG or a code token in AST. For example, the content in a node may be referred to as a code snippet irrespective of whether the content in the node is a statement or a token. In certain examples, the node embedding may be a 20-dimensional vector describing the attributes of the involved code snippet. For example, comments are not included in code snippets due to the various coding styles and vague reference scope. The C/C++ code snippets are first segmented into code tokens via a clang tool. The computing device may determine a classification for the token. For example, the classification of the token may be one of four types: keywords (e.g., if), identifiers (variable and function names), literals (strings and numbers), and punctuation (e.g., ++). Finally, the computing device may extract the features highly related to security patch detection.

The machine-learning prediction model, PatchGNN, may be able to learn the vulnerability patterns from both the syntax-level and semantic-level representations. The semantic representation maybe exhibited by the patchCPG structure with diverse edge relationships, while the syntax-level representation may be achieved by the node embeddings of code snippets. For example, source code vulnerabilities have a high correlation with some specific syntax characteristics. For instance, the pointer and array usages have a higher possibility to be vulnerable in C/C++ language since these operations usually lead to the out-of-bounds (OOB) access or NULL pointer dereference. Moreover, several specific arithmetic expressions can indicate potential improper operations (e.g., integer overflow). Based on the observed syntax characteristics of vulnerabilities, the following 20 features belonging to 5 groups are extracted from the code snippet of each node.
Code Snippet Metadata (2): the number of characters, the version information (e.g., deleted, added, or context).
Identifier and Literal Features (7): the number of function calls, variables, numeric numbers, strings, pointers, arrays, and null identifiers.

TABLE I
The involved tokens or sub-tokens of the control flow
features, the operator features, and the API features

| Features | Matched Tokens or Sub-tokens |
|---|---|
| condition | if, switch |
| loop | for, while |
| jump | return, break, continue, goto, throw, assert |
| arithmetic | ++, −−, +, −, *, /, %, =, +=, −=, *=, /=, %= |
| relational | ==, !=, >=, <=, >, < |
| logical | &&, ∥, !, and, or, not |
| memory API | alloc, free, mem, copy, new, open, close, delete, create, release, |
| | sizeof, remove, clear, dequene, enquene, detach, attach |
| string API | str, string |
| str, string | lock, mutex, spin |
| system API | init, register, disable, enable, put, get, up, down, inc, dec, add, sub, |
| | set, map, stop, start, prepare, suspend, resume, connect, |

† Operator * is determined as dereference operator or arithmetic operator.
* Operator & is determined as address-of operator or bitwise operator.

Control Flow Features (3): the boolean features indicating if the node is a conditional, loop, or jump statement.
Operator Features (4): the number of arithmetic, relational, logical, and bitwise operators.
API Features (4): the boolean features indicating if the code snippet contains the APIs of memory operations, string operations, lock operations, and system operations.

In certain examples, the node embedding is a numeric vector composed of the above twenty code features. The metadata features may be directly derived, while the identifier and literal features may be based on the clang tokenization and the identified token types. The control flow features and operator features may be determined by the exact matching of token keywords, as listed in Table I. Since the API names are defined by developers, the computing device may provide a set of sub-tokens based on prior observations (as shown in the last four rows in Table I). If a function name contains one of these sub-tokens, the corresponding API feature may be enabled. Also, the sub-token matching scheme may be case insensitive.

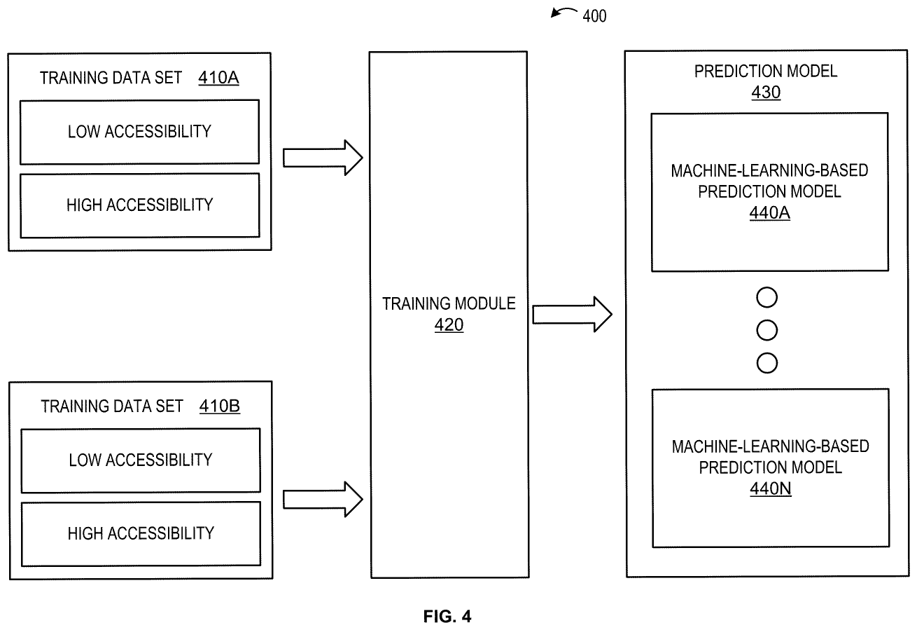

Machine-learning and other artificial intelligence techniques may be used to train a prediction model, such as the PatchGNN prediction model. The prediction model, once trained, may be configured to determine or predict whether a software patch is a security patch or a non-security patch. The prediction model (referred to herein as the at least one prediction model 230, or simply the prediction model 430) may be trained by a system 400 as shown in FIG. 4. The system 400 may be part of the computing device 601, 602 or one or more other separate computing devices configured to provide the prediction model 230 to the computing device 601, 602, for analysis of the plurality of target patches.

The system 400 may be configured to use machine-learning techniques to train, based on an analysis of one or more training datasets 410A-410B by a training module 420, the at least one prediction model 430. The at least one prediction model 430, once trained, may be configured to determine or predict if a target software patch is a security patent or a non-security patch based on an evaluation of a patchCPG generated based on the target software patch. A dataset may be determined or derived from a plurality of software patches, both security software patches and non-security software patches. For example, historical software patches may be used by the training module 420 to train the at least one prediction model 430. Each of the patchCPGs derived from the historical software patches and the identifier of the type of software patch (e.g., a security software patch or a non-security software patch) may be associated with one or more multimodal features of a plurality of multimodal features that are associated with the determination or prediction of whether a software patch is a security software patch or a non-security software patch. The plurality of multimodal features and example software patches and associated identifiers may be used to train the at least one prediction model 430.

The training dataset 410A may comprise a first portion of the historical software patches in the dataset. Each historical software patch may have an associated patchCPG 228, the identifier of the type of software patch (e.g., a security software patch or a non-security software patch) and one or more labeled multimodal features associated with the associated patchCPG 228 and software patch type. The training dataset 410B may comprise a second portion of the historical software patches in the dataset. Each historical software patch may have an associated patchCPG 228, the identifier of the type of software patch (e.g., a security software patch or a non-security software patch), and one or more labeled multimodal features associated with the patchCPG 228 and software patch type. The historical software patches, and associated patchCPG 228 and software patch type may be randomly assigned to the training dataset 410A, the training dataset 410B, and/or to a testing dataset. In some implementations, the assignment of historical software patches and associated patchCPG 228 and software patch type to a training dataset or a testing dataset may not be completely random. In this case, one or more criteria may be used during the assignment, such as ensuring that similar numbers of historical software patches with different software patch types and/or multimodal features are in each of the training and testing datasets. In general, any suitable method may be used to assign the historical software patches and associated patchCPG 228 and software patch type to the training or testing datasets.

The training module 420 may use the first portion and the second portion of the historical software patches and associated patchCPG 228 and software patch type to determine one or more multimodal features that are indicative of an accurate (e.g., a high confidence level for the) software patch type. That is, the training module 420 may determine which multimodal features associated with the patchCPG 228 are correlative with an accurate prediction of the software patch type. The one or more multimodal features indicative of an accurate prediction of the software patch type may be used by the training module 420 to train the prediction model 430. For example, the training module 420 may train the prediction model 430 by extracting a feature set (e.g., one or more multimodal features) from the first portion in the training dataset 410A according to one or more feature selection techniques. The training module 420 may further define the feature set obtained from the training dataset 410A by applying one or more feature selection techniques to the second portion in the training dataset 410B that includes statistically significant features of positive examples (e.g., accurate prediction of software patch type based on the patchCPG 228) and statistically significant features of negative examples (e.g., inaccurate prediction of software patch type based on the patchCPG 228 generated based on the software patch). The training module 420 may train the prediction model 430 by extracting a feature set from the training dataset 410B that includes statistically significant features of positive examples (e.g., accurate prediction of software patch type based on the patchCPG 228 for the software patch) and statistically significant features of negative examples (e.g., inaccurate prediction of software patch type based on the patchCPG 228 generated based on the software patch).

The training module 420 may extract a feature set from the training dataset 410A and/or the training dataset 410B in a variety of ways. For example, the training module 420 may extract a feature set from the training dataset 410A and/or the training dataset 410B using a multimodal detector. The training module 420 may perform feature extraction multiple times, each time using a different feature-extraction technique. In one example, the feature sets generated using the different techniques may each be used to generate different machine-learning-based prediction models 440. For example, the feature set with the highest quality metrics may be selected for use in training. The training module 420 may use the feature set(s) to build one or more machine-learning-based prediction models 440A-440N that are configured to predict a software patch type based on the patchCPG 228 created based on the historical software patch.

The training dataset 410A and/or the training dataset 410B may be analyzed to determine any dependencies, associations, and/or correlations between multimodal features and the software patch types in the training dataset 410A and/or the training dataset 410B. The identified correlations may have the form of a list of multimodal features that are associated with different software patch types. The multimodal features may be considered as features (or variables) in the machine-learning context. The term “feature,” as used herein, may refer to any characteristic of an item of data that may be used to determine whether the item of data falls within one or more specific categories or within a range. By way of example, the features described herein may comprise one or more multimodal features.

A feature selection technique may comprise one or more feature selection rules. The one or more feature selection rules may comprise a multimodal feature occurrence rule. The multimodal feature occurrence rule may comprise determining which multimodal features in the training dataset 410A occur over a threshold number of times and identifying those multimodal features that satisfy the threshold as candidate features. For example, any multimodal features that appear greater than or equal to 5 times in the training dataset 410A may be considered as candidate features. Any multimodal features appearing less than 5 times may be excluded from consideration as a feature. Other threshold numbers may be used in the place of the example 5 times presented above.

A single feature selection rule may be applied to select features or multiple feature selection rules may be applied to select features. The feature selection rules may be applied in a cascading fashion, with the feature selection rules being applied in a specific order and applied to the results of the previous rule. For example, the multimodal feature occurrence rule may be applied to the training dataset 410A to generate a first list of multimodal features. A final list of candidate multimodal features may be analyzed according to additional feature selection techniques to determine one or more candidate multimodal feature groups (e.g., groups of multimodal features that may be used to predict a software patch type based on the patchCPG 228 generated based on the software patch). Any suitable computational technique may be used to identify the candidate multimodal feature groups using any feature selection technique such as filter, wrapper, and/or embedded methods. One or more candidate multimodal feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine-learning algorithms used by the system 400. Instead, features may be selected on the basis of scores in various statistical tests for their correlation with the outcome variable (e.g., a predicted viewing window).

As another example, one or more candidate multimodal feature groups may be selected according to a wrapper method. A wrapper method may be configured to use a subset of features and train the prediction model 430 using the subset of features. Based on the inferences that are drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate multimodal feature groups. Forward feature selection is an iterative method that begins with no features. In each iteration, the feature which best improves the model is added until an addition of a new variable does not improve the performance of the model. As another example, backward elimination may be used to identify one or more candidate multimodal feature groups. Backward elimination is an iterative method that begins with all features in the model. In each iteration, the least significant feature is removed until no improvement is observed on removal of features. Recursive feature elimination may be used to identify one or more candidate multimodal feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate multimodal feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 420 has generated a feature set(s), the training module 420 may generate the one or more machine-learning-based prediction models 440A-440N based on the feature set(s). A machine-learning-based prediction model (e.g., any of the one or more machine-learning-based prediction models 440A-440N) may refer to a complex mathematical model for data classification that is generated using machine-learning techniques as described herein. In one example, a machine-learning-based prediction model may include a map of support vectors that represent boundary features. By way of example, boundary features may be selected from, and/or represent the highest-ranked features in, a feature set.

The training module 420 may use the feature sets extracted from the training dataset 410A and/or the training dataset 410B to build the one or more machine-learning-based prediction models 440A-440N for each classification category (e.g., software patch type based on the patchCPG 228 generated based on the software patch). In some examples, the one or more machine-learning-based prediction models 440A-440N may be combined into a single machine-learning-based prediction model 440 (e.g., an ensemble model). Similarly, the prediction model 430 may represent a single classifier containing a single or a plurality of machine-learning-based prediction models 440 and/or multiple classifiers containing a single or a plurality of machine-learning-based prediction models 440 (e.g., an ensemble classifier).

The extracted features (e.g., one or more candidate multimodal features) may be combined in the one or more machine-learning-based prediction models 440A-440N that are trained using a machine-learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting prediction model 430 may comprise a decision rule or a mapping for each candidate multimodal feature in order to determine a predicted software patch type based on the patchCPG 228 created based on the software patch). As described further herein, the resulting prediction model 430 may be used to determine or predict whether a software patch is a security software patch or a non-security software patch based on the patchCPG 228 generated based on the particular software patch.

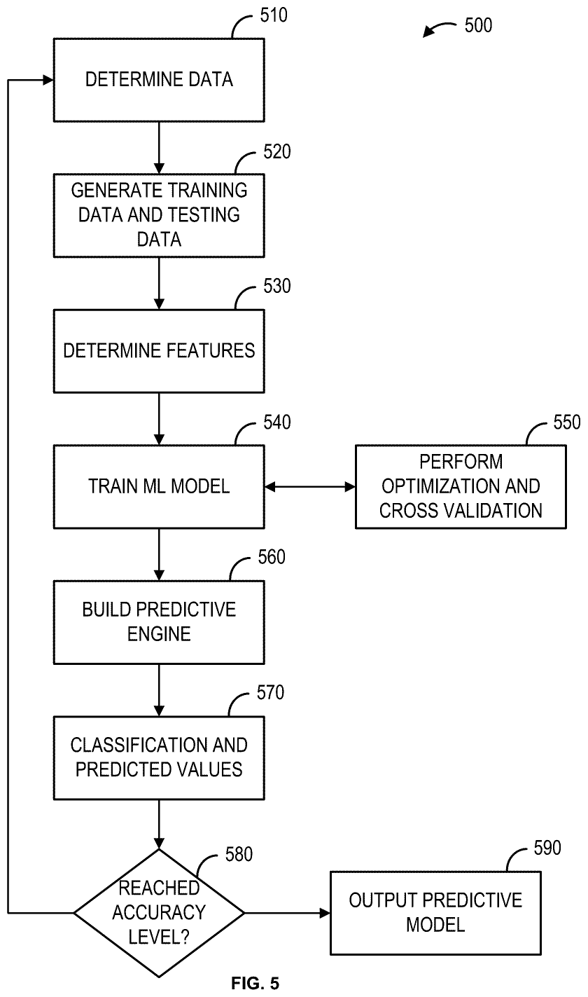

FIG. 5 is a flowchart illustrating an example training method 500 for generating the prediction model 430 using the training module 420. The training module 420 can implement supervised, unsupervised, and/or semi-supervised (e.g., reinforcement based) machine-learning-based prediction models 440A-440N. The method 500 illustrated in FIG. 5 is an example of a supervised learning method; variations of this example of training method are discussed below, however, other training methods can be analogously implemented to train unsupervised and/or semi-supervised machine-learning models. The method 500 may be implemented by the computing devices 601, 602 or by another computing device, such as a separate machine-learning computing system.

At 510, the training method 500 may determine (e.g., access, receive, retrieve, etc.) first historical software patches, associated patchCPGs 228 generated based on those software patches, and identifiers of the type of each software patch (e.g., a security software patch or a non-security software patch) (e.g., the first portion of the historical software patches described above) and second historical software patches, associated patchCPGs 228 generated based on those software patches, and the identifier of the type of software patch for each software patch (e.g., the second portion of the historical software patches described above). The first historical software patches and the second historical software patches may each comprise one or more multimodal features and a predetermined software patch type based on the patchCPG 228 generated based on the software patch and associated source code for the software. The training method 500 may generate, at 520, a training dataset and a testing dataset. The training dataset and the testing dataset may be generated by randomly assigning historical software patches and associated patchCPGs 228 and software patch types from the first historical software patches and/or the second historical software patches to either the training dataset or the testing dataset. In some implementations, the assignment of historical software patches and associated patchCPGs 228 and software patch types as training or test samples may not be completely random. As an example, only the historical software patches and associated patchCPGs 228 and software patch types for a specific multimodal feature(s) and/or type(s) of software patch may be used to generate the training dataset and the testing dataset. As another example, a majority of the historical software patches and associated patchCPGs 228 and software patch types for the specific multimodal feature(s) and/or type(s) of software patch may be used to generate the training dataset. For example, 75% of the historical software patches and associated patchCPGs 228 and software patch types for the specific multimodal feature(s) and/or type(s) of software patch may be used to generate the training dataset and 25% may be used to generate the testing dataset.

The training method 500 may determine (e.g., extract, select, etc.), at 530, one or more features that can be used by, for example, a classifier to differentiate among different classifications (e.g., software patch types). The one or more features may comprise a set of multimodal features. As an example, the training method 500 may determine a set features from the first historical software patches and associated patchCPGs 228 and software patch types. As another example, the training method 500 may determine a set of features from the second historical software patches and associated patchCPGs 228 and software patch types. In a further example, a set of features may be determined from other historical software patches and associated patchCPGs 228 and software patch types of the plurality of historical software patches and associated patchCPGs 228 and software patch types (e.g., a third portion) associated with a specific multimodal feature(s) and/or type(s) of software patch. In other words, the other historical software patches and associated patchCPGs 228 and software patch types (e.g., the third portion) may be used for feature determination/selection, rather than for training. The training dataset may be used in conjunction with the other historical software patches and associated patchCPGs 228 and software patch types to determine the one or more features. The other historical software patches and associated patchCPGs 228 and software patch types may be used to determine an initial set of features, which may be further reduced using the training dataset.

The training method 500 may train one or more machine-learning models (e.g., one or more prediction models) using the one or more features at 540. In one example, the machine-learning models may be trained using supervised learning. In another example, other machine-learning techniques may be employed, including unsupervised learning and semi-supervised learning. The machine-learning models trained at 540 may be selected based on different criteria depending on the problem to be solved and/or data available in the training dataset. For example, machine-learning models can suffer from different degrees of bias. Accordingly, more than one machine-learning model can be trained at 540, and then optimized, improved, and cross-validated at 550.

The training method 500 may select one or more machine-learning models to build the prediction model 430 at 560. The prediction model 430 may be evaluated using the testing dataset. The prediction model 430 may analyze the testing dataset and generate classification values and/or predicted values (e.g., a predicted software patch type for the software patch provided in the testing dataset) at 570. Classification and/or prediction values may be evaluated at 580 to determine whether such values have achieved a desired accuracy level (e.g., a confidence level for the predicted software patch type). Performance of the prediction model 430 may be evaluated in a number of ways based on a number of true positives, false positives, true negatives, and/or false negatives classifications of the plurality of data points indicated by the prediction model 430.

For example, the false positives of the prediction model 430 may refer to a number of times the prediction model 430 incorrectly assigned an accurate software patch type to a historical software patch based on the patchCPG 228 associated with the software patch with a low confidence level. Conversely, the false negatives of the prediction model 430 may refer to a number of times the machine-learning model assigned an inaccurate software patch type to a historical software patch based on patchCPG 228 associated with the software patch with a high confidence level. True negatives and true positives may refer to a number of times the prediction model 430 correctly assigned a software patch type to a historical software patch based on the patchCPG 228 associated with the software patch based on the known, software patch type for the particular software patch and associated patchCPG 228. Related to these measurements are the concepts of recall and precision. Generally, recall refers to a ratio of true positives to a sum of true positives and false negatives, which quantifies a sensitivity of the prediction model 430 Similarly, precision refers to a ratio of true positives, a sum of true and false positives. When such a desired accuracy level (e.g., confidence level) is reached, the training phase ends and the prediction model 430 may be output at 590; when the desired accuracy level is not reached, however, then a subsequent iteration of the training method 500 may be performed starting at 510 with variations such as, for example, considering a larger collection of historical software patches and associated patchCPGs 228 and software patch types.

The prediction model 430 may be output at 590. The prediction model 430 may be configured to provide a predicted software patch type to a software patch based on the patchCPG 228 for the software patch for software patches that are not within the plurality of historical software patches used to train the prediction model. For example, the prediction model 430 may be trained and output by a first computing device. The first computing device may provide the prediction model 430 to a second computing device. As described herein, the method 500 may be implemented by the computing device 601, 602 or another computing device.

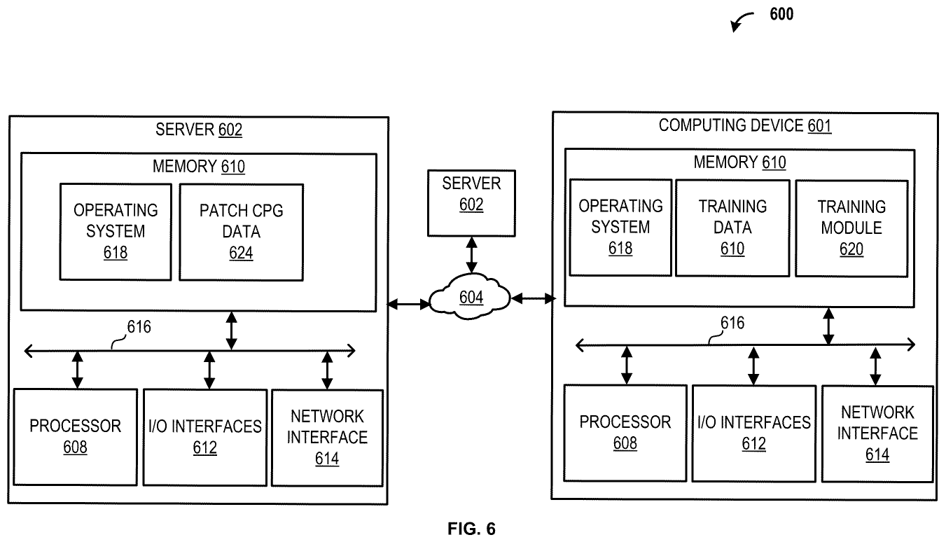

As discussed herein, the present methods and systems may be computer-implemented. FIG. 6 shows a block diagram depicting an environment 600 comprising non-limiting examples of a computing device 601 and a server 602 connected through a network 604. In an aspect, some or all steps of any described method herein may be performed on a computing device as described herein. The computing device 601 can comprise one or multiple computers configured to store one or more of the training module 620, training data 610, and the like. The server 602 can comprise one or multiple computers configured to store, send, and/or transmit power, data, communications, and/or content data (e.g., a plurality of content items). Multiple servers 602 can communicate with the computing device 601 via the through the network 604.

The computing device 601 and the server 602 may each be a digital computer that, in terms of hardware architecture, generally includes a one or more processors 608, memory system 610, input/output (I/O) interfaces 612, and network interfaces 614. These components (608, 610, 612, and 614) are communicatively coupled via a local interface 616. The local interface 616 can be, for example, but not limited to, one or more buses or other wired or wireless connections, as is known in the art. The local interface 616 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The one or more processors 608 can be hardware device(s) for executing software, particularly that stored in memory system 610. The one or more processors 608 can be any custom made or commercially available processor, a central processing unit (CPU), an auxiliary processor among several processors associated with the computing device 601 and the server 602, a semiconductor-based microprocessor (in the form of a microchip or chip set), or generally any device for executing software instructions. When the computing device 601 and/or the server 602 is in operation, the one or more processors 608 can be configured to execute software stored within the memory system 610, to communicate data to and from the memory system 610, and to generally control operations of the computing device 601 and the server 602 pursuant to the software.

The I/O interfaces 612 can be used to receive user input from, and/or for providing system output to, one or more devices or components. User input can be provided via, for example, a keyboard and/or a mouse. System output can be provided via a display device and a printer (not shown). I/O interfaces 612 can include, for example, a serial port, a parallel port, a Small Computer System Interface (SCSI), an infrared (IR) interface, a radio frequency (RF) interface, and/or a universal serial bus (USB) interface.

The network interface 614 can be used to transmit and receive from the computing device 601 and/or the server 602 on the network 604. The network interface 614 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The network interface 614 may include address, control, and/or data connections to enable appropriate communications on the network 604.

The memory system 610 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 610 may incorporate electronic, magnetic, optical, and/or other types of storage media. Note that the memory system 610 can have a distributed architecture, where various components are situated remote from one another, but can be accessed by the one or more processors 608.

The software in memory system 610 may include one or more software programs, each of which comprises an ordered listing of executable instructions for implementing logical functions associated with the one or more methods described herein. In the example of FIG. 6, the software in the memory system 610 of the computing device 601 can comprise the training module 620 (or subcomponents thereof), the training data 610, and a suitable operating system (O/S) 618. In the example of FIG. 6, the software in the memory system 610 of the server 602 can comprise, the historical software patches and associated patchCPGs and software type data 624, and a suitable operating system (O/S) 618. The operating system 618 essentially controls the execution of other computer programs and provides scheduling, input-output control, file and data management, memory management, and communication control and related services.

For purposes of illustration, application programs and other executable program components such as the operating system 618 are illustrated herein as discrete blocks, although it is recognized that such programs and components can reside at various times in different storage components of the computing device 601 and/or the server 602. An implementation of the training module 620 can be stored on or transmitted across some form of computer-readable media. Any of the disclosed methods can be performed by computer-readable instructions embodied on computer-readable media (e.g., non-transitory computer-readable media). Computer-readable media can be any available media that can be accessed by a computer. By way of example and not meant to be limiting, computer-readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

To identify the type of a security patch, patchCPG instances 228 will be first transformed into a numeric format and then fed into the PatchGNN machine-learning prediction model 120. To embed a patchCPG 228 into a numeric graph G, the computing device converts the topology into an adjacency matrix and embeds the attributes of edges and nodes. The computing device embeds the edges in patchCPG 228 into 5-dimensional vectors using the corresponding version information and edge types. The computing device embeds the nodes in patchCPG 228 into 20-dimensional vulnerability-relevant features, which are extracted from the node attributes and involved statements. These features may be customized for software patches, so they are crucial for reducing false alarms in security patch detection. For example, node embeddings may contain two code-independent features (e.g., code snippet metadata) and 18 code-dependent features (e.g., features of identifiers, literals, control flows, operators, and APIs). To extract the code-dependent features, the computing device segments the statement in each node as a set of code tokens with different token types. The feature extraction may be based on token (or sub-token) matching and token type recognition.

The architecture of the PatchGNN prediction model 120 may be based on graph convolution networks, which learn the model via message propagation along the neighboring nodes. Since patchCPG 228 contains multiple attributes (e.g., version information, edge types), a multi-attributed convolution mechanism is employed to achieve convolution operations in different subgraphs and aggregate the information from all subgraphs. I, the PatchGNN prediction model 120 is a classification model that can be described formally as fₚ: G(V,E)→[0,1]². The detector output is a vector (p₀, p₁) representing two class probabilities (p₀+p₁=1). The training objective is to find the optimized parameters of fₚ to minimize the cross-entropy, (e.g., min fₚΣ−(y log (p₁)+(1−y) log(p₀)) where y denotes a binary indicator (0 or 1) showing if the input is a real non-security or security patch). A patch type is determined based on the category with a higher possibility in the detection phase.

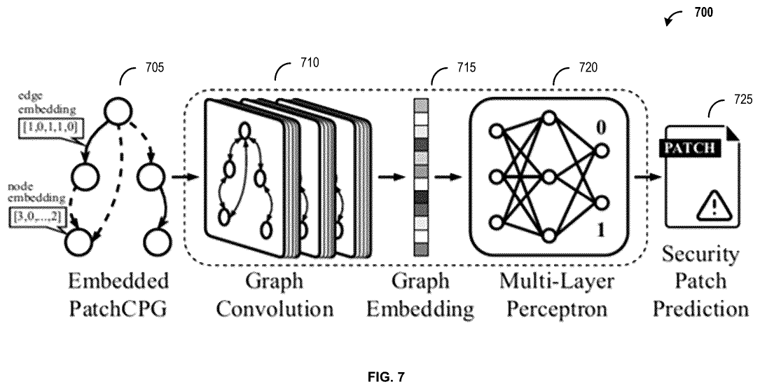

The PatchGNN prediction model 120 is based on graph learning, which provides a great capability of graph classification by neural networks. Due to the diverse edge attributes, patchCPG 228 is a heterogeneous graph. To better leverage the hidden knowledge within patchCPG 228, the PatchGNN model 120 is constructed with a multi-attributed graph convolution mechanism. FIG. 7 shows an example architecture 700 of the PatchGNN prediction model 120. At 705, the patchCPG 228 may be embedded into a numeric format as described above.

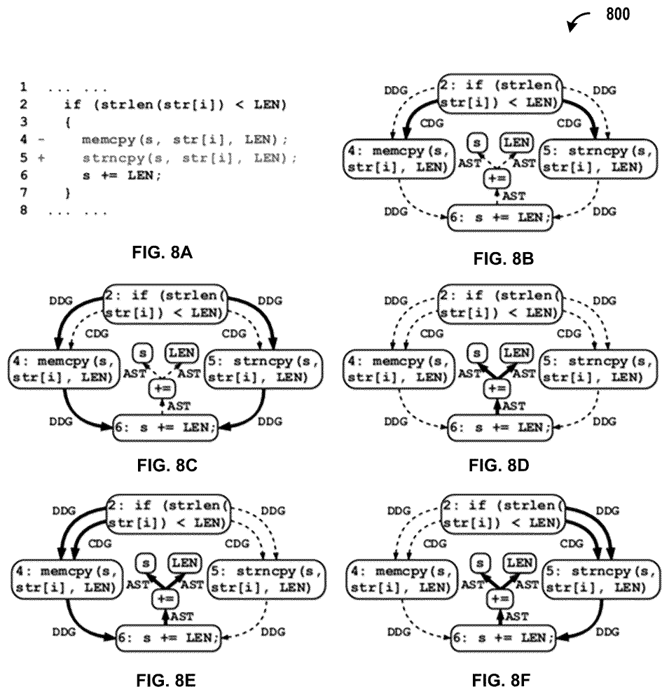

At 710, the patchCPG instances 228 are fed into three multi-attributed graph convolutional layers. The graph convolutional layers will update the node embeddings of patchCPG 228 with the neighborhood information in different subgraphs. In certain examples, three convolutional layers are used in the PatchGNN prediction model 120 because more convolution may lead to graph over-smoothing. However, in other examples, greater or fewer than three convolutional layers may be used. For each node in patchCPG 228, the convolutional layers in the PatchGNN prediction model 120 tend to gather information from its neighbors via different types of edges. Due to the different roles of edge types, the computing device and model 120 may not be able to use a set of unified weights to learn the detection model 120. Each dimension of the edge embeddings can indicate different relationships in patchCPG 228 (e.g., pre-patch/post-patch connections, control/data dependencies, and AST graph). As shown in the example subgraphs 800 of patchCPG 228 of FIGS. 8A-F, each edge can have multiple attributes while each type of attribute can be used to construct a subgraph. As the information in each dimension corresponds to a subgraph, the computing device can view each dimension as an individual convolution channel. In the convolutional layers of the PatchGNN prediction model 120, the computing device processes the structural information of each channel individually and aggregates the processed information of all subgraphs.

The matrix of edge embeddings is denoted as E, where E_{d}^{(k)} is the k-th attribute of the d-th edge. E^{(k)} is a vector contains the k-th attribute of all edges. Because E_{d}^{(k)} can be either 0 or 1, the computing device generates a masked adjacency matrix M^{(k)} according to E^{(k)}, where Mᵢⱼ^{(k)}=1 if the edge connecting node i and node j has the k-th attribute of 1, else Mᵢⱼ^{(k)}=0. M^{(k)} may be used to reflect the node connections of the k-th subgraph. The multi-attributed graph convolution can be formulated as

$${X}^{( h + 1 )} = \frac{1}{K} {\sum }_{k = 1}^{K} σ ( ( A ⊙ {M}^{( k )} + {I}_{N} ) \cdot {X}^{( h )} \cdot {W}_{h}^{( k )} ) , \qquad ( 1 )$$

where A is the adjacency matrix of patchCPG 228, I_{N} is the identity matrix of size N, and ⊙ is the Hadamard product. X^{(h)} is the node embeddings in the h-th convolution layer. Wₕ^{(k)} is the convolution weights of the k-th subgraph in the h-th layer, which is obtained by graph model learning. K is the total number of subgraphs and o is the activation function.

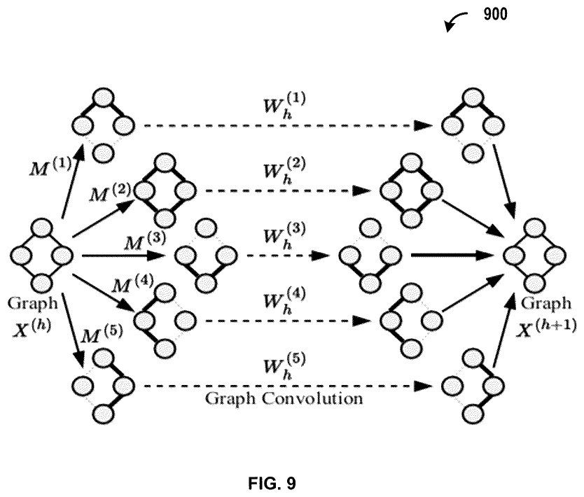

As illustrated in the example graph convolution method 900 of FIG. 9, the structural information from different subgraphs may be aggregated to the convolution result X^{(h+1)} by the multi-attributed graph convolution. The masked adjacency matrix M^{(k)} can be thought of as a filter that provides individual attention for each subgraph to learn convolution parameters.

Since the output of convolutional layers are graphs, the computing device may need to conduct further processing to obtain the final predictions. At 715, after the three-layer graph convolution, graph embeddings may be obtained by the graph pooling and vector concatenation. For example, the graph pooling layers are leveraged to reduce the data dimension and acquire the graph embeddings. For example, graph embedding is a type of graph representation where all the nodes, edges, and their features are transformed into a unified vector. The computing device may use both mean pooling and max pooling to obtain two graph representations, each of which is a high-dimensional vector. Then, these two graph representations are concatenated to construct a final graph embedding, which contains all information of the nodes, edges, and their features in a patchCPG 228. Afterwards, a dropout layer may be performed as a regularization method to prevent over-fitting in the model training.

At 720, a binary predictor constructed by multiple layer perceptron (MLP) may be utilized to convert the graph embeddings into predicted labels. For example, to determine if a patch is security-related, a 3-layer perceptron is built to transform the graph embedding into a 2-unit softmax output (p₀, p₁), where p₀+p₁=1. Each unit in the output indicates the probability that a patch instance falls into the category of non-security patch or security patch. The PatchGNN prediction model 120 is the first end-to-end deep learning model that determines if a patch 725 is security-related directly from its graph-structured information.

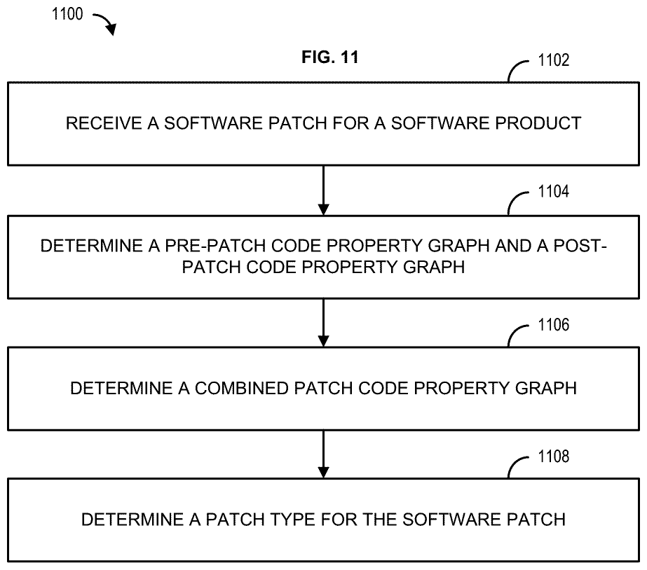

FIG. 11 shows a flowchart of an example method 1100 for determining a patch type for a software patch. The methods described in FIG. 11 may be completed by a computing device, such as the computing device 601, 602, or any other computing device.

At 1102, a software patch for a software product may be received. For example, the software patch may be received by a first computing device from a second computing device. For example, the software patch may be received by the computing device 602. For example, the software patch may be any of the types of software pages described above.

For example, the computing device 602 may determine and/or receive the pre-patch source code 206 for the software product and associated with the software patch 202. For example, the pre-patch source code 206 may be the source code for the software product immediately before the software patch 202 is applied to the software product. For example, the pre-patch source code 206 may be determined and/or received based on the software patch 202. For example, an identifier associated with the software patch 202 may indicate the software product and/or source code that the software patch is intended to be applied to. For example, the computing device 602 may determine and/or receive the post-patch source code 208 for the software product and associated with the software patch 202. For example, the post-patch source code 208 may be the updated source code for the software product after the software patch 202 is applied. For example, the post-patch source code 208 may be determined and/or received based on the software patch 202. For example, an identifier associated with the software patch 202 may indicate the software product and/or source code that the software patch is intended to be applied to.

A plurality of functions 212 in the pre-patch source code 206 may be determined by the computing device 602 or another computing device. The functions 212 in the pre-patch source code 206 and associated with the software patch 202 may be determined. For example, the functions 212 in the pre-patch source code 206 and associated with the software patch 202 may be determined based on the software patch 202. For example the functions 212 may be functions that are a part of and/or are associated with the functions in the software patch 202. For example, the determined functions associated with the software patch may comprise a portion of functions of the plurality of functions 212 in the pre-patch source code 206. A second portion of functions of the plurality of functions in the pre-patch source code 206 may be removed from the pre-patch source code. For example, the second portion of the functions may comprise functions that are not a part of and/or not associated with the functions in the software patch 202.

A plurality of functions 214 in the post-patch source code 208 may be determined by the computing device 602 or another computing device. The functions 214 in the post-patch source code 208 and associated with the software patch 202 may be determined. For example, the functions 214 in the post-patch source code 208 and associated with the software patch 202 may be determined based on the software patch 202. For example the functions may be functions that are a part of and/or are associated with the functions in the software patch 202. For example, the determined functions associated with the software patch 202 may comprise a portion of functions of the plurality of functions in the post-patch source code 208. A second portion of functions of the plurality of functions in the post-patch source code may be removed from the post-patch source code 208. For example, the second portion of the functions may comprise functions that are not a part of and/or not associated with the functions in the software patch 202.

At 1104, a pre-patch code property graph 218 (pre-patchCPG) and a post-patch code property graph 220 (post-patchCPG) may be determined. For example, the pre-patch CPG 218 and post-patchCPG 220 may be determined by the computing device 602 or another computing device. For example, the pre-patchCPG 218 may be determined based on the software patch 202. For example, the pre-patchCPG 218 may be determined based on the pre-patch source code 206. For example, the post-patchCPG 220 may be determined based on the software patch 202. For example, the post-patchCPG 220 may be determined based on the post-patch source code 208.

At 1106, a combined patch code property graph (combined patchCPG) may be determined. For example, the combined patchCPG may be the intermediate complete patchCPG 224 or the patchCPG 228 of FIG. 2. For example, the combined patchCPG may be determined by the computing device 602 or another computing device. For example, the combined patchCPG may be determined based on the pre-patchCPG 218 and the post-patchCPG 220. For example, the combined patchCPG may be a combination or fusion of the pre-patchCPG 218 and the post-patchCPG 220. For example, the combined patchCPG may comprise one or more of a deleted component, an added component, or a context component. For example, the deleted component may have been included in the pre-patchCPG 218. For example, the added component may have been included in the post-patchCPG 220. For example, the context component may have been included in one or both of the pre-patchCPG 218 or the post-patchCPG 220.

A backward slicing technique 226 may be performed on the patch code property graph. For example, the backward slicing technique 226 may be performed on the combined patchCPG. A forward slicing technique 226 may be performed on the patch code property graph. For example, the forward slicing technique 226 may be performed on the combined patchCPG. All or a portion of the combined patchCPG may be transformed into a numerical format. For example, the backward slicing, forward slicing, and/or numerical transformation may be completed by the computing device 602 or another computing device.

At 1108, a patch type for the software patch may be determined. For example, the patch type may be determined by the computing device 601, 602 or another computing device. For example, the patch type may be determined based on the pre-sliced or post-sliced combined patchCPG. For example, the patch type may be determined based on a machine-learning prediction model as described above. For example, the patch type may comprise one of a security patch or a non-security patch.

To test the PatchGNN prediction model's accuracy and effectiveness in identifying security patches and non-security patents two benchmark datasets were selected: PatchDB and SPI-DB. PatchDB is a security patch dataset that contains over 12,000 security patches and 24,000 non-security patches in the C/C++ language. The PatchDB a NVD-based dataset crawled from the NVD reference hyperlinks and a wild-based dataset collected from GitHub commits. The samples in PatchDB are derived from 311 open source repositories (e.g., Linux kernel, MySQL, OpenSSL, Vim, Wireshark, httpd, QEMU, etc.), providing the chance to test the cross-project performance of security patch detection. SPI-DB is a security patch dataset originally collected from Linux, FFmpeg, Wire-shark, and QEMU, including 38,291 patches. Only a portion of the dataset on FFmpeg and QEMU was released, containing 25,790 patches (about 10,000 security patches and about 15,000 non-security patches). Overall, the above two datasets provide PatchGNN prediction model 120 with sufficient patch variants for evaluating cross-project and intra-project performance. Also, the sample ratio can balance the real-world utility and the model fitting.

The PatchGNN prediction model 120 contains three multi-attributed convolutional layers 710, each reducing the dimension of node embeddings to one-half of the original one. In addition, the first layer may aggregate subgraph information with concatenation, while the last two layers may use the mean aggregation. The number of subgraphs (K) may be five, including pre-patch/post-patch graph, control/data dependency graph, and AST graph. Therefore, the dimension of node embeddings after the 1st, 2nd, and 3th convolution 710 is 50, 25, and 12, respectively. For the predictor, the dropout rate may be set to 0.5 during the model training. The dimension of hidden layers in the final multi-layer perceptron 720 may be (24, 8, 2). For the model learning, 80% of randomly selected samples are used to train the model parameters and the remaining 20% samples are used for testing. This ratio holds for both security patches and non-security patches. Also, we do not separate the training/test set by the repository. The batch size is set to 128 and the learning rate is 0.01.

A comparison was conducted with two categories of the state-of-art approaches. First, a direct comparison was made with other security patch detection methods. For example, the RNN-based solutions that utilize a twin RNN scheme to determine if the patch is security-related were chosen. Specifically, two RNN modules with shared weights are deployed to process the pre-patch and post-patch code sequences, respectively. An RNN-based model named TwinRNN was reproduced. Since commit messages highly rely on maintenance policies and some commit messages are not accurate or even empty, the Twin-RNN model was implemented only leveraging the source code revision, which meets practical needs in the real world and provides a fair comparison with the model disclosed herein.

Since few works utilize source code to identify security patches directly, existing vulnerability detection tools are leveraged to assist security patch detection. Given the pre-patch and post-patch functions, it is assumed these tools can identify security patches only if they can detect the vulnerabilities in the pre-patch function but cannot detect those vulnerabilities in the post-patch version. Three common baseline approaches are selected including Cppcheck, flawfinder, and ReDeBug as well as two other most effective works in this field, i.e., VUDDY and VulDecPecker. Among them, Cppcheck and flawfinder are rule-based vulnerability detection tools, ReDeBug and VUDDY are clone-based methods, and VulDeePecker is a learning-based approach.

The prediction model of the present disclosure may be regarded as a classification model, so both general metrics and special metrics are used to evaluate the classification model's effectiveness and practicality. General metrics, including accuracy and F1-score, are used to evaluate the overall performance of the classification model. Special metrics are used to evaluate the practicability of the detection system, including precision and false-positive rate (FPR).

As illustrated in Table II below, the methods described in the present disclosure can achieve up to 80.39% accuracy with a F1-score of 0.557 on PatchDB. On SPI-DB, the accuracy of the methods described in the present disclosure is 63.04% with 0.503 F1-score. Note the performances on PatchDB and SPI-DB are not comparable because the data distributions are different in these two datasets. PatchDB is collected based on the similarity with NVD samples. To construct SPI-DB, raw patches are pre-screened with security-related keywords in commit messages. Then the filtered samples are labeled manually. We adopt both datasets as baseline to compare our work with existing solutions in next subsection.

A comparison of the results using the methods described in the present disclosure with the results of TwinRNN over both PatchDB and SPI-DB datasets is made by applying the same training and test set splitting. The experimental results are summarized in Table II. As shown in Table II, the methods of the present disclosure outperform TwinRNN with 10.8% higher accuracy and 0.096 higher F1-score on PatchDB. On the SPI-DB, the methods of the present disclosure can outperform TwinRNN with 6.67% higher accuracy with a minuscule drop in F1-score (less than 0.01). Compared with the previous work, the main difference of the methods described in the present disclosure is to capture more enriched syntax and semantics via graph-based patch representation and patch-tailored feature extraction, thus the methods of the present disclosure are more effective than other sequential models.

TABLE II
The performance comparison of GraphSPD and RNN-based
sequential model for security patch detection

| | | General Metrics | | Special Metrics | |
|---|---|---|---|---|---|
| Method | Dataset | Accuracy | F1-score | Precision | FP Rate |
| TwinnRNN | PatchDB | 69.60% | 0.461 | 48.45% | 19.67% |
| | SPI-DB | 56.37% | 0.512 | 49.07% | 41.57% |
| PatchGNN | PatchDB | 80.39% | 0.557 | 77.27% | 5.05% |
| prediction | SPI-DB | 63.04% | 0.503 | 63.96% | 19.16% |
| model | | | | | |

In addition, to effectively reduce the update frequency and increase labor efficiency, precision and false positive rates are important metrics. When performing the methods of the present disclosure on PatchDB, Table II shows 77.27% of predicted security patches are real security-related, and only 5.05% of real non-security patches are misidentified. However, when using TwinRNN, only 48.45% of predicted security patches are real, incurring low efficiency in the practical applications. Due to the extreme imbalance between non-security and security patches in OSS (security ones only account for 6-10%), false positives matter more than false negatives. Therefore, the methods of the present disclosure aim to reduce false positive rate while keeping the same level of false negative rate. The false-positive rate in our system is only a quarter of that in other RNN-based systems, with the same level of false-negative rate (56.51% for the methods of the present disclosure and 55.95% for TwinRNN). That means in practice the number of false alarms reported by TwinRNN is above four times more than that reported using the methods of the present disclosure, while the number of detected real security patches is the same. On SPI-DB, the methods of the present disclosure outperform TwinRNN in precision by 14.89 percentage points and the false positive rate using the methods of the present disclosure is only half that of TwinRNN.

Due to the fact that few works use code revision to directly identify security patches, state-of-the-art vulnerability detection tools were utilized to identify security patches since they are supposed to detect vulnerabilities in the vulnerable version and cannot detect such vulnerabilities in the patched version. Five effective techniques were applied, including Cppcheck, flawfinder, ReDeBug, VUDDY, and VulDeePecker on a dataset including 368 security patches of known common vulnerabilities and exposures from five projects. The pre-patch (vulnerable) and post-patch (patched) code of related functions are retrieved to see if these tools can detect the security patches, i.e., detect vulnerabilities in pre-patch code without incurring any false positives in post-patch code.

For VUDDY and VulDeePecker, their provided fingerprint dictionary or training dataset was directly used to train the model. Since ReDeBug does not provide an individual dataset for template generation, the same PatchDB dataset was employed to train both ReDeBug and the PatchGNN prediction model 120 of the present disclosure. These training samples have no overlapping with above 368 security patches.

TABLE III
Comparison results with existing vulnerability
detection methods on 368 security patches

| Method | # Vul_{pre-patch} | # Vul_{post-patch} | # Patch_{security} | TP Rate |
|---|---|---|---|---|
| Cppcheck | 3 | 1 | 2 | 0.54% |
| ReDeBug | 109 | 108 | 1 | 0.27% |
| VUDDY | 29 | 29 | 0 | 0.00% |
| VulDeePecker | 22 | 16 | 21 | 5.71% |
| GraphSPD | 3 | 0 | 3 | 0.82% |
| | — | — | 53 | 14.40% |

Table III shows the number of vulnerabilities detected in pre-patch and post-patch code, respectively. For a security patch, a detector may falsely report its patched version as vulnerable, unpatched version as invulnerable, or even both versions as vulnerable or invulnerable. Cppcheck detects 3 vulnerabilities in pre-patch code and 1 out of them is detected as vulnerable in post-patch code, which means Cppcheck only detects 2 security patches. Flawfinder reports 109 and 108 vulnerabilities in pre-patch and post-patch code, respectively. Among them, the overlapping 108 vulnerabilities are detected in both versions of code. A security patch can only be determined if its pre-patch version is vulnerable while its post-patch version is invulnerable. Therefore, only one security patch can be successfully detected by Flawfinder. ReDeBug detects 29 vulnerabilities in both pre-patch and post-patch code, which means no security patches can be detected. VUDDY detects 22 vulnerabilities in pre-patch code, where 21 out of them are correctly detected as secure in the post-patch version. Thus, 21 security patches are identified by VUDDY. Note that these 16 vulnerabilities detected in the post-patch code do not correspond to the same patches as the previous 22 vulnerabilities. VulDeePecker only identifies 3 and 0 vulnerabilities in the pre-patch and post-patch code, respectively, so it can only detect 3 security patches.

In contrast, using the methods of the present disclosure detects 53 out of 368 security patches, which outperforms the true positive rate of Cppcheck, flawfinder, ReDeBug, VUDDY, and VulDeePecker by 13.58, 14.13, 14.40, 8.69, and 13.58 percentage points, respectively. As such it is concluded that vulnerability detection approaches may be applied to detect security patches, but their performances are not good for practical use. It also shows the value of using the methods of the present disclosure for security patch detection.

Furthermore, to better learn how the methods of the present disclosure outperform other approaches, patch cases only detected by the methods of the present disclosure are studied and exemplify three scenarios (S1-S3) as follows.

In scenario S1, as shown in Listing 4, the pre-patch code already checks current_frame (Line 2) before operating on it (Line 6). However, this patch fixes a double free by changing the field length (i.e., replace current_frame with keyframe). Rule-based methods cannot detect it since its pre-patch version looks secure, but actually it is vulnerable. As a learning-based method, the methods of the present disclosure are capable of detecting it since similar samples have already been included in the training dataset, as shown in Listing 5.

Listing 4: Security patch for a double free (CVE-2011-3934)

| 1 | commit 247d30a7dba6684ccce4508424f35fd58465e535 | |
|---|---|---|
| 2 | if (!s1−>current_frame.data[0] | |
| 3 | | \|\|s−>width != s1−>width |
| 4 | | \|\|s−>height!= s1−>height) { |
| 5 | | if (s != s1) |
| 6 | − | copy_fields(s, s1, golden_frame, current_frame); |
| 7 | + | copy_fields(s, s1, golden_frame, keyframe); |
| 8 | | return −1; |
| 9 | | } |

Listing 5: A patch with similar patterns (CVE-2018-16393)

| 1 | commit 360e95d45ac4123255a4c796db96337f332160ad | |
|---|---|---|
| 2 | if (priv−>cac_id_len) { | |
| 3 | | serial−>len=MIN(priv−>cac_id_len, SC_MAX_SERIALNR); |
| 4 | − | memcpy(serial−>val,priv−>cac_id,priv−>cac_id_len); |
| 5 | + | memcpy(serial−>val,priv−>cac_id,serial−>len); |
| 6 | | SC_RETURN(card−>ctx,SC_DEBUG_NORMAL,SC_SUCCESS); |
| 7 | | } |

In scenario S2, the patches involve complex control flow changes. The security patch in Listing 6 fixes an uninitialized cred pointer and determines control flow via cred. However, rule-based methods cannot detect it since cred is not present in pre-patch function (i.e., lack of key information to detect uninitialized use). Moreover, since it is difficult to generalize rule-based methods in complex control flow changes, it is challenging to summarize a general rule for this case.

Listing 6: Security patch for uninit use (CVE-2009-2768)

| | |
|---|---|
| 1 | commit 3440625d78711bee41a84cf29c3d8c579b522666 |
| 2 | if (IS_ERR(bprm.file)) |
| 3 | return res; |
| 4 | + bprm.cred = prepare_exec_creds( ); |
| 5 | + res = −ENOMEM; |
| 6 | + if (!bprm.cred) |
| 7 | + goto out; |
| 8 | res = prepare_binprm(&bprm); |
| 9 | if (res <= (unsigned long)−4096) |
| 10 | res = load_flat_file(&bprm, libs, id, NULL); |
| 11 | − if (bprm.file) { |
| 12 | − allow_write_access(bprm.file); |
| 13 | − fput(bprm.file); |
| 14 | − bprm.file = NULL; |
| 15 | − } |
| 16 | + abort_creds(bprm.cred); |
| 17 | + out: |
| 18 | + allow_write_access(bprm.file); |
| 19 | + fput(bprm.file); |
| 20 | return(res); |

In scenario S3, the patch in Listing 7 shows an uncommon pattern for fixing a double free. Instead of deleting free statements, developers can also guarantee the memory does not get freed before the release. Since usbtv will be freed twice via usbtv_video_free( ) and kfree( ) this patch increments the reference count of usb device structure to avoid double free. Such a pattern is hard to be described in the studied rule-based methods.

Listing 7: The security patch for a double free on Linux kernel

| 1 | commit 50e7044535537b2a54c7ab798cd34c7f6d900bd2 | |
|---|---|---|
| 2 | usbtv_audio_fail: | |
| 3 | + | /* we must not free at this point */ |
| 4 | + | usb_get_dev(usbtv−>udev); |
| 5 | | usbtv_video_free(usbtv); |
| 6 | usbtv_video_fail: | |
| 7 | | usb_set_intfdata(intf, NULL); |
| 8 | | usb_put_dev(usbtv−>udev); |
| 9 | | kfree(usbtv); |

TABLE IV
The performance comparison of the methods of the present disclosure
with different scope of context (slicing iteration number N).

| Slicing | General Metrics | | Special Metrics | |
|---|---|---|---|---|
| Iteration No. (N) | Accuracy | F1-score | Precision | FP Rate |
| 0 | 80.19% | 0.555 | 76.11% | 5.42% |
| 1 | 80.39% | 0.557 | 77.27% | 5.05% |
| 2 | 79.24% | 0.531 | 73.61% | 5.87% |
| ∞ | 76.90% | 0.501 | 64.42% | 8.95% |

Context statements can assist the detection of security patches by involving more dependencies and semantics. However, as stated above, too much context can introduce interfering noise to the detection model. Therefore, the scope of context will directly affect the detection performance. Experiments were conducted to evaluate the impact of different context scope on system performance for the methods described in the present disclosure. The context scope is represented by the iteration number of program slicing with the added/deleted statements as criterion, which is denoted as N. In each iteration, statements are extracted that have control/data dependency with current criterion statements. The system performance is evaluated on the constructed patchCPGs with four different settings:
(a) N=0: only changed statements (i.e., no slicing).
(b) N=1: changed statements and direct context statements.
(c) N=2: changed statements along with direct and nearest indirect context statements.
(d) N=∞: changed statements along with all direct and indirect context statements.

Table IV shows that the methods of the present disclosure may achieve the best performance when only considering direct context statements (N=1). Compared with no context (N=0), direct context may facilitate the security patch detection by complementing more semantic information. The performance gets worse when N is greater than 1, since indirect context may introduce too much noise and provide limited valuable information. The accuracy drops by 1.15% when N=2, indicating that the indirect context does not carry much relevance for the changed code. The accuracy further drops by 3.49% when considering all the indirect context (N=∞), because most of these context statements are barely correlated with the changed statements but introduce excessive noise that significantly interferes with the detection model.

The experiments prove that program slicing is a straight-forward and effective method to control the context scope, compared with other methods (e.g., the weighting scheme). For example, as discussed herein, there is a trade-off between semantics and noise when considering context statements in patchCPGs. Besides the program slicing scheme, other ways were tried to reduce the impact of irrelevant nodes and prevent over-fitting. One attempt was to use different weights to present the importance of context nodes. That is to say, for the patchCPGs without slicing, we set weights less than or equal to one to the context nodes, artificially intervening the contextual information.

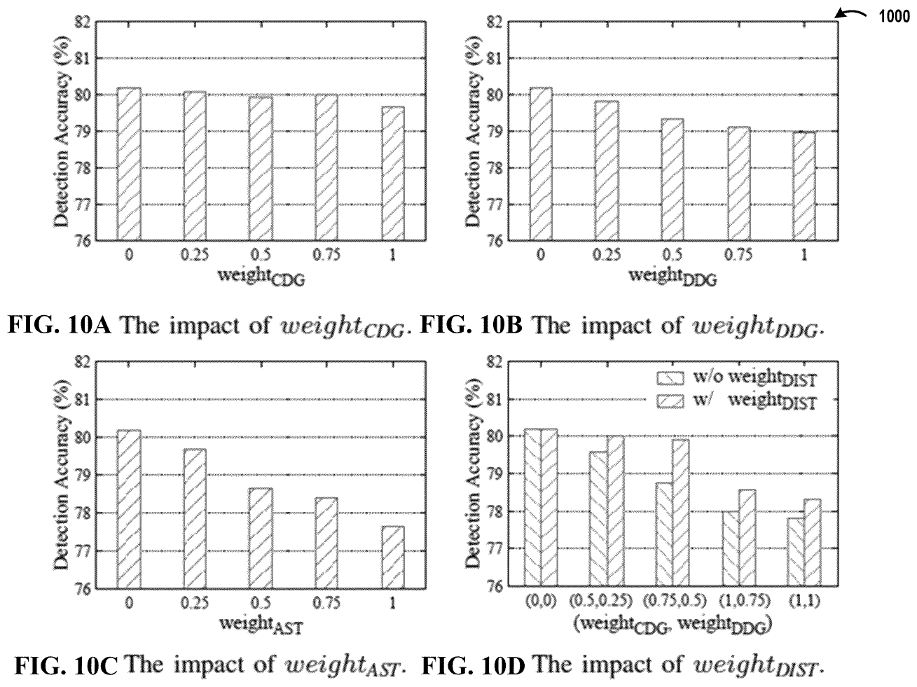

In certain examples, the weights were set based on different types of context nodes. Not all the nodes in a graph contribute equal to the predictions. Due to the different roles of CDG, DDG, and AST, a straightforward idea is to set three component weights (i.e., weightCDG, weightDDG, and weightAST) for different context nodes. In the cases that a context node exists in two or more components, the weight is determined by the largest component weight applicable to this node. To evaluate the impact of different component weights, the control variates method was utilized. The detection accuracy was measured by setting one weight to different values and leaving others to 0s. The experimental results 1000 are shown in the example weight impact graphs of FIGS. 10A-C.

The following was observed,
(a) The weighting scheme has lower accuracy than code slicing since all irrelevant nodes are retained without any control/data dependency with the changed code.
(b) The detection accuracy will reduce with the increase of all these component weights.
(c) Compared with CDG, the accuracy can drop more significantly with higher DDG or AST weights.
(d) A higher weight_{AST} will dramatically reduce the accuracy since too many AST nodes can lead to over-fitting. Thus, it is better to remove AST components for context nodes (i.e., weight_{AST}=0).

In certain examples, the weights were set based on the distance of context nodes. Another trial is to decide the weights according to the distance of context nodes towards the added/deleted nodes (i.e., hop count). The objective of this method is to assign larger weights for more direct context. A distance weight may be defined as weight_{DIST}=1/(1+d), where d is the min hop count between a context node and changed nodes (e.g., the distance weight of 1-hop context nodes is ½). In this trial, the context node weight is the product of component weight and distance weight. Multiple comparative experiments were conducted to analyze the impact of weight DIST with different combinations of component weights. Based on the previous observations, we set weight_{AST}=0 and weight_{CDG}≥weight_{DDG} in the experiments. In FIG. 10D, the distance weight is determined to effectively boost the performance because it inhibits the effect of irrelative context nodes far away from the changed ones. However, since the best performance was achieved with 1-hop context only, context weights are not added in final design. Rather, The direct context of program slicing provides the most valuable information for inference, and the indirect context has limited relevance to the changed statements but introduces noise.

As a large-scale real-world dataset, PatchDB provides the possibility of evaluating system performance for the methods described in the present disclosure over different patch types, which are manually labelled according to the types of resolved vulnerabilities. Table V illustrates the performance of methods described in the present disclosure for different patch types, which are ranked with the severity of corresponding vulnerabilities.

TABLE V
The performance of GraphSPD over patches
with different vulnerability types.

| Severity | Vulnerability Type of Patch | Proportion | TP Rate |
|---|---|---|---|
| 1 | buffer overlow | 18% | 30.9% |
| 2 | improper input validation | 2% | 5.8% |
| 3 | resource leakage | 22% | 71.4% |
| 4 | double free/use after free | 5% | 51.1% |
| 5 | integer overflow | 5% | 37.2% |
| 6 | NULL pointer dereference | 12% | 66.0% |
| 7 | improper authentication | 4% | 14.7% |
| 8 | uncontrolled resource consumption | 1% | 33.3% |
| 9 | race condition | 7% | 56.6% |
| 10 | uninitialized use | 8% | 27.5% |
| n/a | other vulnerabilities | 16% | 16.7% |

The proportion for each patch type is also listed, as well as the corresponding true-positive rate (TPR) using the methods of the present disclosure. The overall recall using the methods of the present disclosure is 43.5%, which is the same as that of RNN models.

By analyzing the performance over each type of security patches, two key findings emerge. First, for security patch types with higher TPR, the corresponding patches exhibit distinguishable features from non-security ones, shedding light on the detection system design. For instance, resource leakage is usually fixed with memory reinitialization and file operations, hence associated with memory APIs. Moreover, the race condition fixing always utilize the lock/unlock operations to restrict processes/threads, thus the patches are related to the lock APIs.

For example, some security patch types (e.g., resource leakage, NULL pointer dereference, race condition, and double free/use after free) exhibit distinguishable features. Accordingly, experiments show the methods of the present disclosure achieve a higher true positive rate in these specific types.
1) Resource Leakage. We find 3 patterns for resource leakage: re-initialization, memory operations, and file operations.
(a) Re-initialization. An effective method to mitigate memory leakage vulnerability is to re-initialize the memory space to default values, such as 0s. An example:
   +memset (&link, 0, sizeof(link));
(b) Memory Release. Resource leakage may occur when software developers forget to release the memory. Thus, the corresponding patches will involve memory function calls such as release( ) and free( ) An example:
   +free (*appliance);
(c) File Close. Information can be leaked via the unreleased file pointer. Therefore, the corresponding patches will involve file function calls such as fclose( ). An example:
   +if (file!=NULL)
   +fclose(file);
2) NULL Pointer Dereference. The vulnerability of NULL pointer dereference occurs when using an invalid pointer without checking its value. Therefore, the patches will use sanity checks (if statements) to verify the validity of pointer before usage. Moreover, the conditions always involve NULL, which accords with our feature of null identifiers. Example:
   +if (tmpjobid==NULL)
   +return(NULL);
3) Race Condition. Race condition occurs when the system attempts to execute two or more operations simultaneously. The effective method to avoid race condition is to use lock/unlock operations to restrict the processes and threads. Therefore, the patches are usually related to the lock APIs. An example:
   +mutex_lock(&pool->pool_lock);
   list_add(&ce->node, &pool->curlring);
   pool->curls++;
   +mutex_unlock (&pool->pool_lock);
4) Double Free/Use After Free. Double free occurs when free( ) is called more than once with the same memory address. Use-after-free occurs when using an invalid memory that has already been freed. Four common patterns are as follows:
(a) Remove Second Use/Free. For double free, a straightforward fixing method is to remove the extra free operation. The patch is related to the memory APIs. An example:
   free(comment_header);
(b) Move Use Before Free. For the use-after-free, some patches will move the statements to the lines before the free operation. This type of security patch is detected using the control dependency in patchCPG. An example:
   +atomic_dec(&chip->active);
   if (!chip->num_interfaces)
   snd_card_free(chip->card);
   −atomic_dec(&chip->active);
(c) Initialize Pointer to NULL. To prevent using an invalid pointer, developers can initialize the pointer to NULL and use it. An example:
   +info->port=NULL;
(d) Check Before Use. To exclude invalid pointers, developers can check the validity before using the pointer. The patches can add corresponding sanity check. An example:
   −*image=(rbd_image_t)ictx;
   +if(r>=0)+
   *image=(rbd_image_t) ictx;

Second, the security patch types with low TPR are usually associated with security check modifications (e.g., improper input validation, buffer overflow, and improper authentication), which usually use if statements to restrict the operating range. Although security check is a typical pattern for security patches, sometimes it is easy to get mixed up with non-security patterns since developers also like to use conditional statements to add new features in specific cases. Seizing clues from context becomes even more decisive in these cases. Also, data imbalance affects detection over these security patches; for instance, uncontrolled resource consumption only counts for 1% in training set, providing insufficient patterns for deep learning. This effect will be mitigated by having more data.

Besides large-scale datasets like PatchDB and SPI-DB, further performance testing was completed using the methods of the present disclosure on four other popular OSS to evaluate the adaptability of the proposed systems and methods. For example, NGINX (a web server software), Xen (a hypervisor project), OpenSSL (a TLS/SSL and crypto library), and ImageMagick (an image processing tool) were selected for evaluation. Note that all samples used in this case study are not included in the training set. The detection outputs (e.g., a security patch or a non-security patch) using the methods of the present disclosure were manually checked by three experienced security researchers, who cross-checked their analysis results. The security researchers identified a security patch if it fixes a vulnerability belonging to any CWE types.

With regards to NGINX, the computing device collected commits between neighboring major versions from NGINX's GitHub repository and applied the methods of the present disclosure after filtering out invalid commits that did not contain source code changes. As shown in Table VII, there are 180 commits between NGINX 1.19.0 and 1.21.0 (two neighboring mainline versions). The system retains 127 valid commits that have code changes. After being transformed into patchCPGs 228 and fed into PatchGNN prediction model 120, 7 cases were detected as potential security patches. Six cases were then manually confirmed as real security patches, while the NGINX changelog only shows three cases are reported as security patches in the CVE. Also, the methods of the present disclosure were used to perform detection on the 1.17, 1.15, and 1.13 series of NGINX. Overall, methods disclosed herein detected 27 potential security patches from 787 input commits and 21 out of 27 were subsequently confirmed as real security patches. The detection precision is 78% (only 22% false alarms), which is consistent with the performance on benchmark datasets like PatchDB, showing the considerable generalization ability of methods of the present disclosure.

With regards to Xen, the latest 1,170 commits were obtained from the GitHub repository of Xen and input them into the disclosed system using the methods of the present disclosure. The prediction results show that 29 commits were detected as security patches. 16 of the 29 were verified to be real security patches (i.e., 55% in precision).

With regards to OpenSSL, the methods of the present disclosure were used to evaluate the newest 1,000 commits of the OpenSSL GitHub repository. The methods of the present disclosure determined/predicted 68 commits as security patches, with 45 of those being verified as real security patches, i.e., 66% in precision.

TABLE VII
Security patch detection results on NGINX.

| Changes | | Total | Valid | Detected | Confirmed | |
|---|---|---|---|---|---|---|
| w/ | CVE | Commits | Commits | S.P. | S.P. | Precision |
| 1.19.x | 3 | 180 | 127 | 7 | 6 | 86% |
| 1.17.x | 3 | 134 | 82 | 4 | 3 | 75% |
| 1.15.x | 1 | 203 | 120 | 7 | 4 | 57% |
| 1.13.x | 1 | 270 | 157 | 9 | 8 | 89% |
| Sum | 8 | 787 | 486 | 27 | 21 | 78% |

S.P. = security patches

With regards to ImageMagick, the methods of the present disclosure were used to evaluate the newest 1,000 commits of the ImageMagick GitHub repository. The methods of the present disclosure determined/predicted thirteen as security patches and six of those were manually verified to be real security patches (i.e., 46.2% in precision).

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer-readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, by a computing device, a software patch for a software product;
determining, based on the software patch, a pre-patch code property graph and a post-patch code property graph;
determining, based on the pre-patch code property graph and the post-patch code property graph, a combined patch code property graph; and
determining, based on the combined patch code property graph, a patch type for the software patch.

2. The method of claim 1, further comprising:
receiving pre-patch source code for the software product associated with the software patch; and
receiving post-patch source code for the software product, wherein the pre-patch code property graph is further determined based on the pre-patch source code and wherein the post-patch code property graph is further based on the post-patch source code.

3. The method of claim 2, further comprising:
determining a plurality of functions in the pre-patch source code;
determining, based on the software patch, a portion of the plurality of functions associated with the software patch; and
removing a second portion of the plurality of functions not associated with the software patch from the pre-patch source code.

4. The method of claim 2, further comprising:
determining a plurality of functions in the post-patch source code;
determining, based on the software patch, a portion of the plurality of functions associated with the software patch; and
removing a second portion of the plurality of functions not associated with the software patch from the post-patch source code.

5. The method of claim 1, wherein the combined patch code property graph comprises one or more of a deleted component, an added component, or a context component.

6. The method of claim 1, wherein the patch type for the software patch comprises one of a security patch or a non-security patch.

7. The method of claim 1, further comprising performing a backward slicing technique on at least a portion of the combined patch code property graph.

8. The method of claim 1, further comprising performing a forward slicing technique on at least a portion of the combined patch code property graph.

9. The method of claim 1, further comprising transforming the combined patch code property graph into a numeric format.

10. The method of claim 1, wherein determining the patch type for the software patch is further based on a machine-learning prediction model.

11. An apparatus comprising:
one or more processors; and
memory storing processor-executable instructions that, when executed by the one or more processors, cause the apparatus to:
receive a software patch for a software product;
determine, based on the software patch, a pre-patch code property graph and a post-patch code property graph;
determine, based on the pre-patch code property graph and the post-patch code property graph, a combined patch code property graph; and
determine, based on the combined patch code property graph, a patch type for the software patch.

12. The apparatus of claim 11, wherein the processor-executable instructions, when executed by the one or more processors, further cause the apparatus to:
receive pre-patch source code for the software product associated with the software patch; and
receive post-patch source code for the software product,
wherein the processor-executable instructions that, when executed by the one or more processors, cause the apparatus to determine the pre-patch code property graph, cause the apparatus to further determine the pre-patch code property graph based on the pre-patch source code and
wherein the processor-executable instructions that, when executed by the one or more processors, cause the apparatus to determine the post-patch code property graph, cause the apparatus to further determine the post-patch code property graph based on the post-patch source code.

13. The apparatus of claim 12, wherein the processor-executable instructions, when executed by the one or more processors, further cause the apparatus to:
determine a plurality of functions in the post-patch source code;
determine, based on the software patch, a portion of the plurality of functions associated with the software patch; and
remove a second portion of the plurality of functions not associated with the software patch from the post-patch source code.

14. The apparatus of claim 12, wherein the processor-executable instructions, when executed by the one or more processors, further cause the apparatus to:
determine a plurality of functions in the post-patch source code;
determine, based on the software patch, a portion of the plurality of functions associated with the software patch; and
remove a second portion of the plurality of functions not associated with the software patch from the post-patch source code.

15. The apparatus of claim 11, wherein the patch type for the software patch comprises one of a security patch or a non-security patch.

16. The apparatus of claim 11, wherein the processor-executable instructions, when executed by the one or more processors, further cause the apparatus to perform one or more of a backward slicing technique or a forward slicing technique on at least a portion of the combined patch code property graph.

17. The apparatus of claim 11, wherein the processor-executable instructions that, when executed by the one or more processors, cause the apparatus to determine the patch type for the software patch, further cause the apparatus to determine the patch type based on a machine-learning prediction model.

18. A system comprising:
a first computing device configured to send a software patch; and
a second computing device configured to:
receive the software patch;
determine, based on the software patch, a pre-patch code property graph and a post-patch code property graph;
determine, based on the pre-patch code property graph and the post-patch code property graph, a combined patch code property graph; and
determine, based on the combined patch code property graph, a patch type for the software patch.

19. The system of claim 18, wherein the second computing device is further configured to determine the patch type based on a machine-learning prediction model.

20. The system of claim 18, wherein the patch type for the software patch comprises one of a security patch or a non-security patch.
